(19) United States
(12) Patent Application Publication
(10) Pub. No.: US 2021/0222484 A1
(43) Pub. Date: Jul. 22, 2021

(54) GARAGE DOOR SEAL

(71) Applicant: Tony Sirois, Tilley (CA)

(72) Inventor: Tony Sirois, Tilley (CA)

(21) Appl. No.: 16/749,681

(22) Filed: Jan. 22, 2020

(51) Int. Cl. E06B 7/232; E06B 7/23

(52) U.S. Cl. CPC E06B 7/232; E06B 7/2316

(57) ABSTRACT

An illustrated side view of an exemplary garage door seal apparatus for preventing ices and snow buildup is presented. The exemplary garage door seal apparatus is useful for providing a better door to ground seal. The exemplary garage door seal apparatus further is useful for preventing freezing and protecting door and door motors from damage and can lower heating costs for people with heated garages and commercial shops. Additionally, the exemplary garage door seal apparatus prevents dirt, water, leaves, animals, such as ants, roaches, mice, etc. from entering an interior of a garage.

### FIELD OF THE INVENTION

This invention relates to garage doors. More particularly, it relates to creating a seal at the bottom of a garage door when closed.

### BACKGROUND

A car (or automobile) is a wheeled motor vehicle used for transportation. Most definitions of car say they run primarily on roads, seat one to eight people, have four tires, and mainly transport people rather than goods.

A garage door is a large door on a garage that opens either manually or by an electric motor (a garage door opener). Garage doors are frequently large enough to accommodate automobiles and other vehicles. Small garage doors may be made in a single panel that tilts up and back across the garage ceding. Larger doors are usually made in several jointed panels that roll up on tracks across the garage ceiling, or into a roll above the doorway.

The operating mechanism is spring-loaded or counterbalanced to offset the weight of the door and reduce human or motor effort required to operate the door. Less commonly, some garage doors slide or swing horizontally. Doors are made of wood, metal, or fiberglass, and may be insulated to prevent heat loss. Warehouses, bus garages and locomotive sheds have larger versions.

Garage doors cause injury and property damage (including expensive damage to the door itself) in several different ways. The most common causes of injury from garage door systems include falling doors, pinch points, improperly adjusted opener force settings and safety eyes, attempts at do-it-yourself repair without the proper knowledge or tools, and uncontrolled release of spring tension (on torsion spring systems).

A garage door with a broken spring, or the wrong strength spring, can fall. Because the effective mass of the door increases as the garage door sections transfer from the horizontal to vertical door tracks, a falling garage door accelerates rapidly. A free-falling garage door can cause serious injury or death.

Furthermore, a garage door or doors are useful for moderating the temperature inside of the garage, preventing snow and ice from entering the garage and keeping leaves, dirt, etc. outside of the garage, when the garage is closed and a seal is created between a bottom of the door and the floor of the garage.

Currently, a door seal is typically a rubber semi-circular piece that is glided along a guide at the bottom of the door. These seals often wear out cause wind, cold air, heat, etc. enter under the door or escape to the outside of the garage. Also, this may cause dirt, leaves and small animals, such as ants, roaches, mice, etc., enter into the garage and potentially into an attached house.

In light of the foregoing, there is a need for a device to provide a long-term seal attachable to a bottom of a garage door that prevents the elements, dirt, leaves, and unwanted animals from entering into the garage as well as snow and ice such that the door is not stuck or frozen to the ground.

### BRIEF DESCRIPTION OF THE DRAWINGS

FIG. 1 is an illustrated side view of an exemplary garage door seal apparatus.

FIG. 2 is an illustrated exterior view of the exemplary garage door seal apparatus shown in FIG. 1.

FIG. 3 is an illustrated exterior view of an open garage door having the garage door seal apparatus shown in FIG. 1.

FIG. 4 is an illustrated view of an closed garage door having the exemplary garage door seal apparatus shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

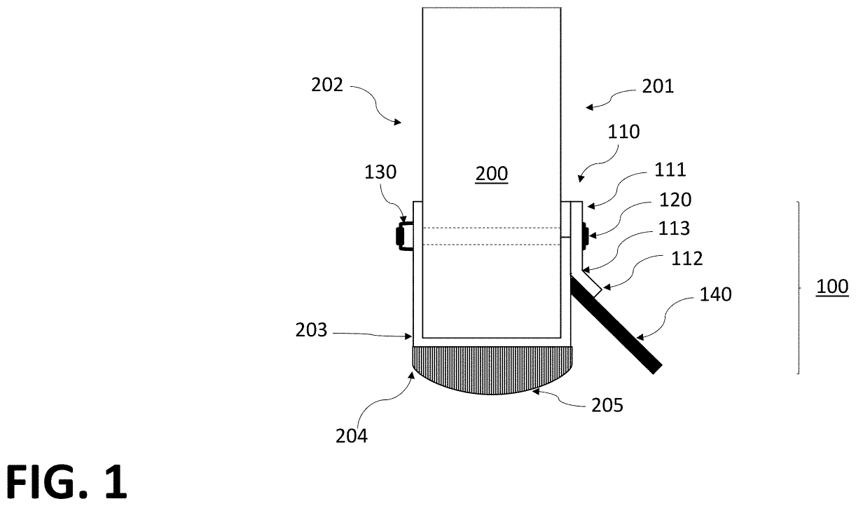

Referring to FIG. 1, an illustrated side view of an exemplary garage door seal apparatus 100 for preventing ices and snow buildup is presented. The exemplary garage door seal apparatus 100 is useful for providing a better door to ground seal. The exemplary garage door seal apparatus 100 further is useful for preventing freezing and protecting door and door motors from damage and can lower heating costs for people with heated garages and commercial shops. Additionally, the exemplary garage door seal apparatus 100 prevents dirt, water, leaves, animals, such as ants, roaches, mice, etc. from entering an interior of a garage.

Currently, a garage door 200 has an exterior side 201, an interior side 202, a bottom side 203 and a guide 204. The guide 204 is typically a metal system in which a traditional rubber strip 205 is slidably coupled to the bottom 203 of the garage door 200. The rubber strip 205 provides a barrier to the garage (not shown) when the garage door 200 is closed. The rubber strip 205 is typically flat when the garage door 200 is closed thus allowing for the rubber strip 205 to become frozen or stuck to the garage floor (not shown) during below 32 degrees Fahrenheit (<32° F.), also referred to as freezing conditions.

For a better seal and freedom from freezing or sticking to a garage floor, the exemplary garage door seal apparatus 100 is coupled to a bottom side 203 of the garage door 200.

The garage door seal apparatus 100 has a plate 110, one or more coupling devices 120, one or more locking devices 130 and a robber 140. The plate 110 is preferably bent at a forty-five-degree (45°) angle, however other angles are hereby contemplated, including, but not limited to, forty degree (40°), fifty degree (50°), etc. The plate 110 is preferably made of an aluminum material, however other materials are hereby contemplated, including, but not limited to, steel, poly-vinyl chloride (PVC), etc. The plate 110 is preferably one-eighth (⅛) inch in thickness, however other thicknesses are hereby contemplated, including, but not limited to one quarter (¼) inch, one-sixteenth ( 1/16) inch, etc. The plate 110 is preferably significantly the same length as a width of the garage door 200.

The plate 110 has an upper end 111 and a lower end 112, the plate 110 has a bend 113 between the upper end 111 and the lower end 112. The bend 113 is preferably forty-five-degrees (45°).

The robber 140 is preferably two and one-half (2.5) inches in width, however other widths are hereby contemplated, including, but not limited to, two (2) inches, three (3) inches, etc. The robber 140 is preferably made of a conveyer belt material, however other materials are hereby contemplated, including, but not limited to, poly-vinyl chloride (PVC), plastic, aluminum, etc.

The coupling devices 120 are preferably carriage bolts, however other types of coupling devices are hereby contemplated, including, but not limited to, screws, anchor screws, etc. The coupling devices 120 are preferably one-quarter (0.25) inches in diameter, however other diameters are hereby contemplated, including, but not limited to, one-eighth (⅛) inch, one-half (½) inch, etc. The coupling devices 120 preferably have a length of three-fourth (0.75) inch, however other lengths are hereby contemplated, including, but not limited to, seven-eighths (⅞) inch, five-eighths (⅝) inch, etc. The locking devices 130 are preferably compatible with the length and diameter of the coupling devices 120. The locking devices 130 are preferably nuts, however other types of locking devices have been contemplated as desired by a person of ordinary skill in the art.

The garage door seal apparatus 100 is assembled under the following steps. Couple the robber 140 to the lower end 112 of the plate 110 by using the coupling devices 120 and the locking devices 130.

After closing the garage door 200, place the garage door seal apparatus 100 at the bottom side 203 of the exterior side 201 of the garage door 200. The upper end 111 of the plate 110 is placed flat against the exterior side 201 of the garage door 200. The robber 140 is positioned and adjusted to be in sealed contact with the ground. Drill holes in the garage door 200, where the holes are for a pathway between the exterior side 201 of the garage door 200 and the interior side 202 of the garage door.

Install the coupling devices 120 through the plate 110, the robber 140 and the garage door 200. Couple the locking devices 130 onto the coupling devices 120 at the interior side 202 of the garage door 200.

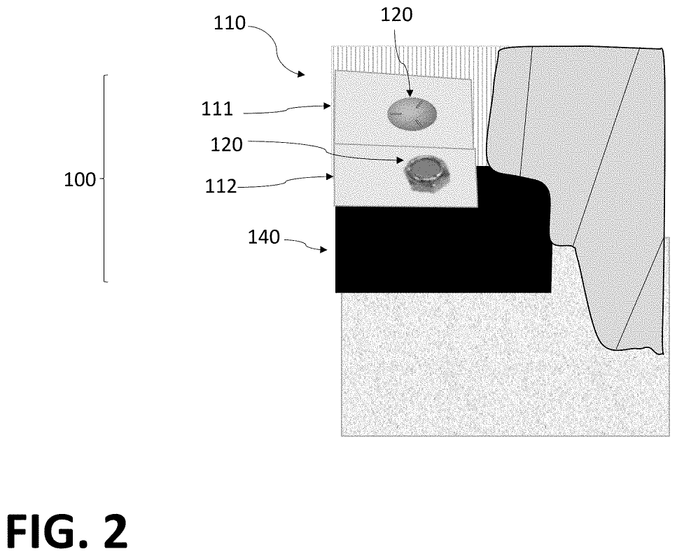

Moving to FIG. 2, an illustrated exterior view of the exemplary garage door seal apparatus 100 shown in FIG. 1 is presented.

The garage door seal apparatus 100 is shown up close. The robber 140 is coupled behind the lower end 112 of the plate 110. One of the coupling devices 120 couples the lower end 112 of the plate 110 to the robber 140. Not shown is the locking device 130 coupled to the coupling device 120 to secure the robber 140 to the plate 110.

Another of the coupling devices 120 has been secured through the upper end 111 of the plate 110 through a previously drilled hole through the garage door 200 and secured into place using a locking device 130 coupled to the coupling device 120.

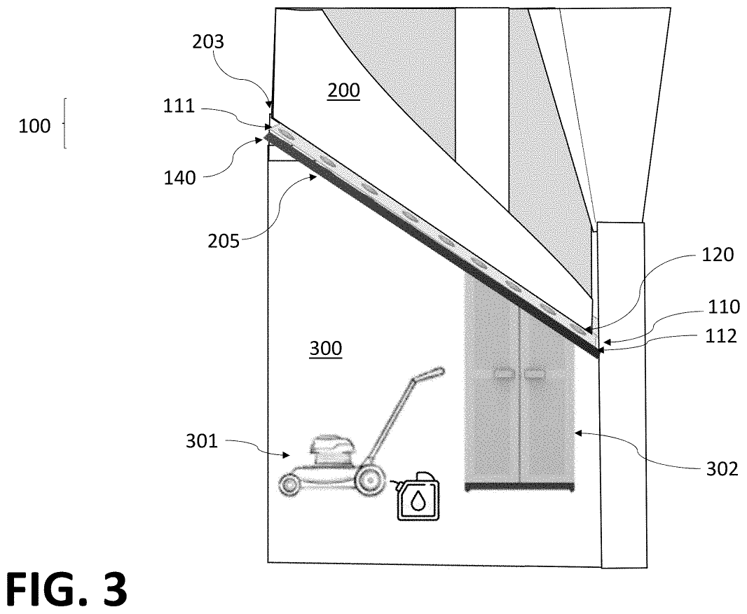

Now in FIG. 3, an illustrated exterior view of an open garage door 200 having the garage door seal apparatus 100 shown in FIG. 1 is presented.

Viewing from outside of the garage 300 to inside of the garage 300, items such as a lawn mower 301, a cabinet 302, etc. are seen in the garage 300. The garage door 200 is in an open state. The bottom side 203 of the garage door 200. The rubber strip 205 is seen as well as the robber 140. The robber 140 is coupled to the lower end 112 of the plate 110. The upper end 111 of the plate 110 is coupled to the bottom side 203 of the garage door 200 by the coupling devices 120.

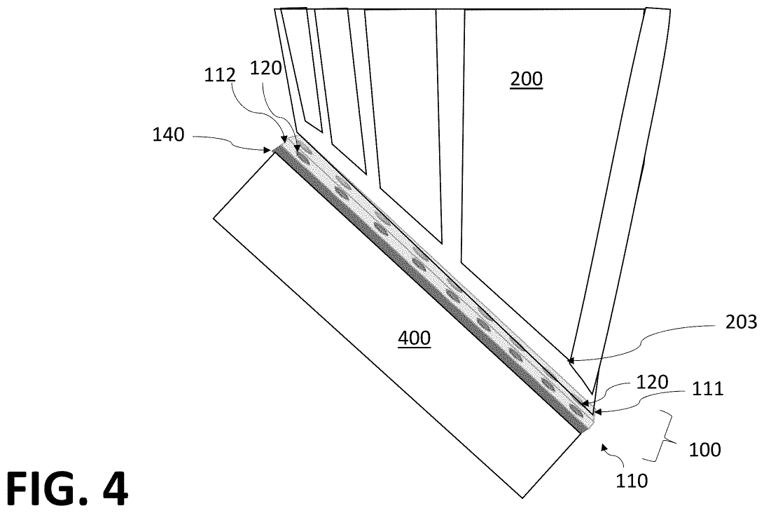

Now in FIG. 4, an illustrated view of an open garage door 200 having the exemplary garage door seal apparatus 100 shown in FIG. 1 is presented.

The bottom side 203 of the garage door 200 is coupled to the garage door seal apparatus 100. The upper end 111 of the plate 110 is coupled to the bottom side 203 of the garage door 200 by the coupling device 120. The lower end 112 of the plate 110 is coupled to the robber 140 by the coupling devices 120. The robber 140 is in contact with the ground 400 such that the ice, snow, dirt, water, etc. can not permeate the robber 140 to make contact with rubber strip (205 of FIG. 1) or to create a path into the garage (300 of FIG. 3).

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A garage door seal apparatus for preventing ice and snow buildup, the apparatus comprising:
a plate, the plate having an upper end, a lower end and a bend, the bend being between the upper end and the lower end;
one or more coupling devices;
one or more locking devices, the one or more locking devices being coupled to the one or more coupling devices; and
a robber, the robber being coupled to the bottom end of the plate by one or more of the coupling devices and wherein the coupling devices being securely coupled to the locking devices; and
wherein the plate being coupled to a garage door by one or more coupling devices and wherein the coupling devices being securely coupled to the locking devices.

2. The apparatus of claim 1, wherein the bend having an angle being forty-five-degrees (45°).

3. The apparatus of claim 1, wherein the plate being made of an aluminum material.

4. The apparatus of claim 1, wherein the plate having a thickness being one-eighth (⅛) inch.

5. The apparatus of claim 1, wherein the plate being substantially the same length as a width of a garage door.

6. The apparatus of claim 1, wherein the robber having a width being two and one-half (2.5) inches.

7. The device of claim 1, wherein the robber being substantially the same length as a width of a garage door.

8. The device of claim 1, wherein the robber being made of a conveyer belt material.

9. The device of claim 1, wherein the coupling devices being carriage bolts.

10. The device of claim 9, wherein the carriage bolts having a length being three-fourths (0.75) inch.

11. The device of claim 9, wherein the carriage bolts having a diameter being one-fourth (¼) inch.

12. The device of claim 1, wherein the locking devices being a nut.

13. The device of claim 1, wherein the locking devices being compatible in diameter to the coupling devices.
